(19) United States
(12) Patent Application Publication
(10) Pub. No.: US 2006/0011834 A1
(43) Pub. Date: Jan. 19, 2006

(54) Low vacuum scanning electron microscope

(76) Inventors: Masako Nishimura, Hitachinaka (JP); Mitsuhiko Yamada, Naka (JP)

Correspondence Address: MCDERMOTT WILL & EMERY LLP, 600 13TH STREET, N.W., WASHINGTON, DC, 20005-3096, US

(21) Appl. No.: 11/178,598

(22) Filed: Jul. 12, 2005

(30) Foreign Application Priority Data
Jul. 13, 2004 (JP) 2004-206108

(51) Int. Cl. G21K 7/00

(52) U.S. Cl. 250/310

(57) ABSTRACT

High resolution observation is achieved at a low acceleration voltage of 5 kV or below under a high pressure condition of a sample chamber. A sample chamber has a double structure and an inner sample chamber for keeping low vacuum is arranged inside an outer sample chamber having high vacuum. A relatively high negative voltage such as −1 to −9 kV for decelerating electrons immediately before a sample is applied between the outer sample chamber and the inner sample chamber. When an incident electron beam passes through an objective lens, an electron beam keeping high energy and having small aberration is formed and is decelerated immediately before the sample to acquire high resolution at a low acceleration voltage.

### BACKGROUND OF THE INVENTION

1. Field of the Invention

This invention relates to a low vacuum scanning microscope that keeps the inside of a sample chamber at lower vacuum than a barrel portion, reduces charge-up of an insulator sample and conducts quick observation of a water-containing sample by omitting a pre-processing.

2. Description of the Related Art

When observation is made by keeping the inside of a sample chamber at a higher pressure (about 1 to about 300 Pa, for example) than at other portions in a low vacuum scanning electron scope, it is customary to detect reflected electrons and to form an image. In the sample chamber kept at a high pressure, however, the probability of impingement between incident electrons and remaining gas molecules inside the sample chamber becomes higher with the increase of the pressure of the sample chamber. Therefore, the mean free path of the incident electrons becomes shorter and scattering occurs, thereby inviting the problems that S/N of the image gets deteriorated and resolution drops in the observation by the low vacuum scanning electron microscope.

A system for acquiring a secondary electron image has gained a wide application in recent years in which the secondary electrons occurring on the sample surface are accelerated by a positive bias electrode arranged at an upper part and are allowed to impinge against the gas molecules remaining in the sample chamber to generate ions and the resulting ions are detected as an absorption current through a sample table. However, particularly because it is difficult to acquire high resolution and S/N at a low acceleration voltage, it has still been difficult to grasp with fidelity the surface structure of the sample. Incidentally, JP-A-5-325859 can be cited as one of the prior art references associated with this invention.

In the existing low vacuum secondary electron detection methods, the signal amount becomes markedly small due to the impingement with the gas molecules inside the sample chamber in the observation at an acceleration voltage of 5 kV or below and the image formation is difficult. In the case a sample made of organic matters such as a living body, in particular, the amount of the secondary electron signal generated is small and the image formation is almost impossible at an acceleration voltage of 7 kV or below. Therefore, information of the outermost surface of the sample cannot be grasped at the existing acceleration voltage even when an attempt is made to grasp the original structure by omitting pre-processing. Improvement in resolution at a low vacuum low acceleration voltage is also the problem yet to be solved.

FIG. 1 shows an example where the Staphylococcus aureus subjected to a customary pre-processing (fixing, dehydration, drying and Os vacuum deposition) is observed through a high resolution low vacuum SEM having a Schottky emission electron gun in comparison with a high vacuum secondary electron image (acceleration voltages of 7 kV and 2 kV) and a low vacuum secondary electron image (acceleration voltage 7 kV). A fine concavo-convex structure of the sample surface can be confirmed in the high vacuum secondary electron image at the acceleration voltage of 2 kV. The acceleration voltage of 7 kV is the limit as to both S/N and resolution in the high magnification observation of the existing low vacuum secondary electron image and the fine concavo-convex structure of the sample surface cannot be confirmed.

FIG. 2 shows an observation example of the Corynebacterium. The pre-processing (fixing, dehydration, drying and Pt vacuum deposition) that has been conducted in the past is made for the high vacuum observation sample. The low vacuum observation sample is fixed, washed and as such observed. A belt-like structure can be clearly confirmed on the sample surface of the image at the high vacuum and 2 kV but cannot be confirmed in high vacuum 10 kV and low vacuum 10 kV.

### SUMMARY OF THE INVENTION

It is an object of the invention to provide a low vacuum scanning electron microscope cable of accomplishing high resolution observation at a low acceleration voltage of 5 kV or below even when a sample chamber pressure is high.

To accomplish the object described above, the invention employs a sample chamber having a double structure in a low vacuum scanning electron microscope for irradiating an electron beam to a sample while a sample chamber pressure is kept at 1 Pa or above, detecting the resulting ions and displaying an image, and arranges a second sample chamber for keeping low vacuum inside a high vacuum sample chamber (called “first sample chamber”).

A positive voltage (0 to 300 V, for example) is applied between the second sample chamber and the sample to accelerate secondary electrons occurring on the sample surface and the secondary ions are allowed to impinge against gas molecules remaining in the sample chamber to generate cascade-wise ionization. Positive (+) ions generated in this instance are detected as absorption current and an image is formed. A relatively high negative voltage of −0.5 to −9 kV, for example, that decelerates the electrons immediately before the sample, is applied between the first and second sample chambers. The incident electron beam forms a thin electron beam under a small lens aberration condition while keeping high energy when the incident electron beam passes through an objective lens and is decelerated immediately before the sample. In this way, high resolution can be acquired at a low acceleration voltage.

The invention can provide a variable pressure type scanning electron microscope capable of conducting decelerated electric field observation for accomplishing high resolution observation at a low acceleration voltage of 5 kV or below even when a sample chamber pressure is high. Consequently, quick and simple high resolution observation of the sample surface can be accomplished while completely omitting the pre-processing that has been necessary for ordinary scanning electron microscope observation.

Other objects, features and advantages of the invention will become apparent from the following description of the embodiments of the invention taken in conjunction with the accompanying drawings.

### BRIEF DESCRIPTION OF THE DRAWINGS

FIG. 1 is a comparative view (observation examples of Staphylococcus aureus) of high vacuum/low vacuum secondary electron images depending on the existence/absence of vacuum deposition;

FIG. 2 is a comparative view (observation examples of Corynebacteria) of high vacuum/low vacuum secondary electron images depending on the existence/absence of vacuum deposition;

FIG. 3 is a conceptual view showing an example of an overall construction of a scanning electron microscope according to the invention;

FIG. 4 is an enlarged sectional view near sample chambers;

FIG. 5 is a sectional view inside the sample chamber when a sample stage is mounted; and

FIG. 6 is a detailed view of a low vacuum exhaust pipe.

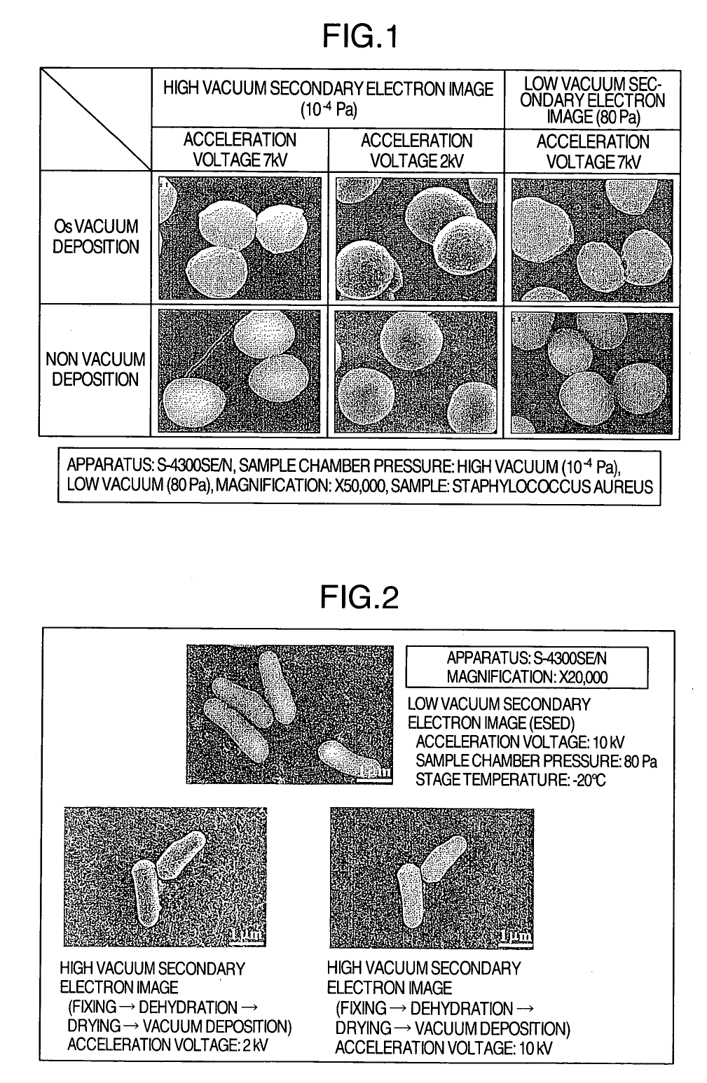

### DESCRIPTION OF THE EMBODIMENTS

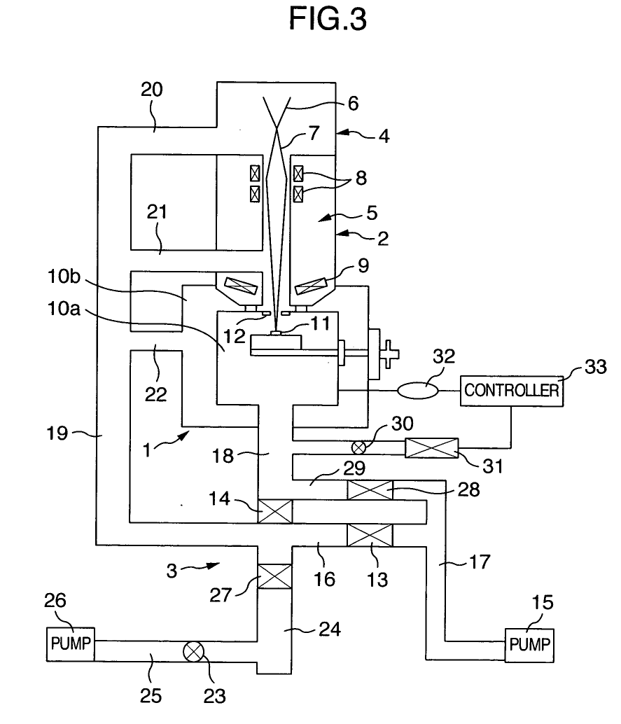

FIG. 3 is a schematic view showing a low vacuum scanning electron microscope according to an embodiment of the invention. The scanning electron microscope includes a sample chamber 1, a barrel portion 2 at an upper stage of the sample chamber 1 and an exhaust system 3 for exhausting the inside of each of the sample chamber 1 and the barrel portion 2. The barrel portion 2 includes an electron gun portion 4 and a lens system (electronic optical system) portion 5. The sample chamber 1 has a double structure of an inner sample chamber 10a and an outer sample chamber 10b that can independently conduct the exhaust operation.

An electron gun 6 such as a thermo-electron gun or a Schottky emission type electron gun is disposed in the electron gun portion 4. The electron beam 7 emitted from the electron gun 6 and accelerated is thinly converged by a condenser lens 8 and an objective lens 9 inside the lens system portion 5 and is irradiated to a sample 11 arranged inside the inner sample chamber 10a. The electron beam 7 is deflected two-dimensionally by a scanning coil for deflection that is provided to the lens system portion 5 and is not shown in the drawing. The electron beam 7 converged in this way scans two-dimensionally the surface of the sample 11. When the sample 11 is scanned by the electron beam 7, secondary electrons and reflected electrons occur from the surface of the sample 11.

A sample having conductivity is observed under the condition where the pressure of the sample pressure is low (high vacuum) such as about 10⁻⁴ Pa and a sample not having conductivity is observed under the condition where the pressure of the sample chamber is high (low vacuum) such as about 1 to about 300 Pa. To keep the pressure of the inner sample chamber 10a at about 1 to 300 pa and the pressure of the barrel portion 2 at about 10⁻⁴ Pa, a stop called “orifice” 12 that has a diameter of hundreds of microns (μm) is formed at the upper part of the inner sample chamber 10a. The sample chamber 10a is differentially exhausted by the exhaust system 3. The electron beam 7 passes through the orifice 12 and is irradiated to the sample 11 placed inside the inner sample chamber 10a. Incidentally, the outer sample chamber 10b is exhausted by the exhaust system 3 to a high vacuum of about 10-4 Pa.

The exhaust system 3 operates in the following way when the inner sample chamber 10a and the barrel portion 2 are exhausted to the same high vacuum of about 10⁻⁴ Pa. First, valves 13 and 14 are opened and the inside of all the barrel portion 2, inner sample chamber 10a and outer sample chamber 10b is preparatively exhausted (rough exhaust) by a preparative exhaust rotary pump 15 through exhaust passages 16 and 17 to 22. A valve 23 is opened at this time and an exhaust passage 25 such as a high vacuum oil diffusion pump or a turbo molecular pump 24 is exhausted by an exhaust rotary pump 26.

Next, when the internal pressure of each of the electron gun portion 4 of the barrel portion 2, the lens system portion 5, the inner sample chamber 10a and the outer sample chamber 10b reaches a predetermined pressure (about 10 Pa), the valve 13 is closed while the valve 27 is opened so that the oil diffusion pump or the turbo molecular pump 24 exhausts the inside of the barrel portion 2 and the inner and outer sample chambers 10a and 10b to the vacuum of 10⁻⁴ Pa through the exhaust passages 18 to 22.

On the other hand, the exhaust system 3 operates in the following way in order to keep the inside of each of the electron gun portion 4 of the barrel portion 2, the lens system portion 5 and the outer sample chambers 10b at the high vacuum of 10⁻⁴ Pa and to exhaust and keep the inner sample chamber 10a at a low vacuum of about 1 to 300 Pa. First, the valve 14 is closed and the valve 28 is opened, so that the rotary pump 15 exhausts the inner sample chamber 10a through the exhaust passages 17 and 29. Next, the valve 30 is opened and the vacuum inside the inner sample chamber 10a is regulated to a pressure of about 1 to about 300 Pa that is arbitrarily set, by a low vacuum control valve 31. The pressure inside the inner sample chamber 10a is measured by a vacuum gauge 32 and a real time pressure feedback controller 33 automatically regulates the difference from the set value. Consequently, the inside of the inner sample chamber 10 is exhausted to and kept at an arbitrary pressure of 1 to 300 Pa and the inside of each of the electron gun portion 4 of the barrel portion 2, the lens system portion 5 and the outer sample chamber 10b is exhausted to the vacuum of 10⁻¹⁴ Pa. The orifice 12 keeps the vacuum.

When the observation is made under the low pressure condition of the sample chamber (high vacuum) such as about 10−4 Pa, the secondary electrons and the reflected electrons occurring from the sample 11 are detected by a secondary electron detector and a reflected electron detector, not shown, are amplified by an amplifier and are then introduced as luminance modulation signals into a display device. Because the display surface of the display device is scanned in synchronism with secondary scanning of the sample 11, the image created by the secondary electrons and the reflected electrons occurring from the sample 11 is displayed on the display surface of the display device.

Under the condition where the pressure of the sample chamber is high (low vacuum) such as about 1 to about 300 Pa, the electron beam 7 impinges against the gas molecules remaining in the sample chamber and ionizes the gas molecules before the electron beam 7 is irradiated to the sample. The electron beam 7 irradiated to the sample electrically charges the surface of the sample 11 but the charging phenomenon of the surface of the sample 11 can be reduced because the gas molecules ionized by the impingement against the electron beam 7 neutralize the electrons charged to the surface of the sample 11.

When observation is made under the high pressure condition of the sample chamber, the reflected electrons occurring from the sample 11 are generally acquired by the reflected electron detector, not shown, arranged at the upper part and the signals of the reflected electron detector are amplified and are then introduced as luminance modulation signals into the display device. On the other hand, the secondary electrons occurring from the surface of the sample 11 are impeded by the remaining gas molecules cannot reach the secondary electron detector because their retention energy is small, and secondary electron information cannot be acquired.

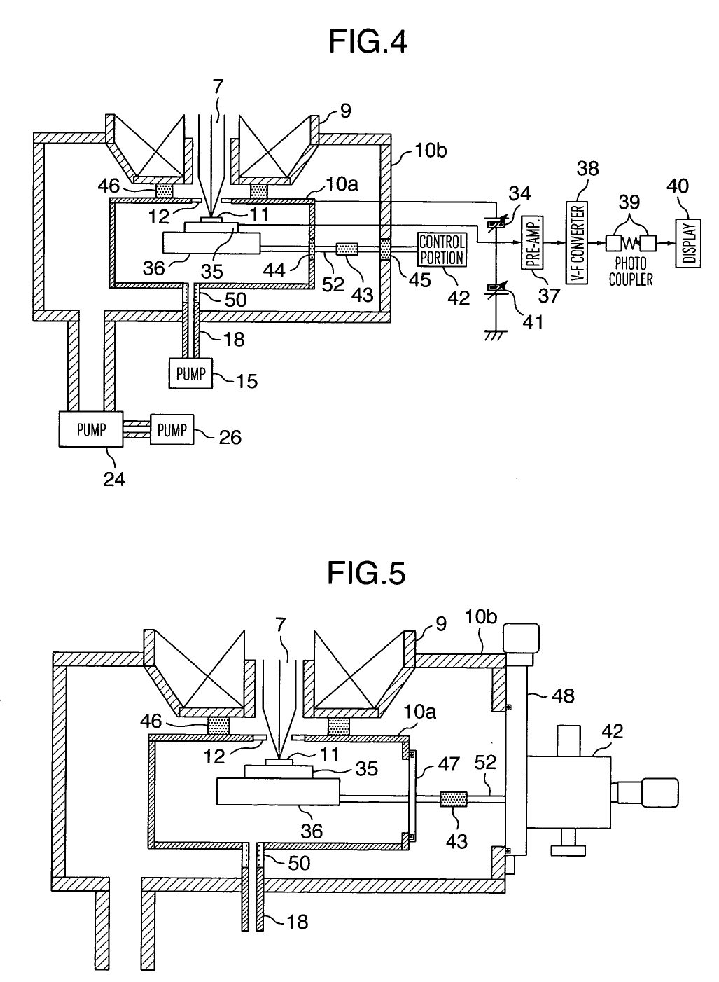

FIG. 4 is an enlarged sectional view showing a structural example near the sample chamber of the scanning electron microscope according to the invention. To acquire secondary electron information, a bias power source 34 applies a positive voltage of 0 to 400 V, for example, to the wall surface of the inner sample chamber 10a so that the secondary electrons occurring from the surface of the sample 11 can be accelerated and are allowed to impinge against the gas molecules remaining inside the sample chamber to thereby generate the ions. The resulting ions move towards the sample owing to the electric field generated between the sample 11 and the wall of the inner sample chamber 10a, and are detected as a sample absorption current from a conductive sample table 35 or a conductive sample stage 36 and are converted to a signal voltage by a pre-amplifier (current-voltage converter) 37. The secondary electron signal converted to the voltage by the pre-amplifier is converted to a frequency signal by a voltage-frequency converter 38 and then to an optical signal and transmitted and received by a photo coupler 39. Only the secondary electron signal is introduced as the luminance modulation signal into the display device 40 while the high voltage is cut off.

A method that applies a retarding voltage for retarding the high acceleration electron beam immediately before the sample is generally known as a high resolution observation method at a low acceleration voltage. When this method is used, resolution can be improved because chromatic aberration of the objective lens can be suppressed to minimum. However, a discharge phenomenon occurs when a high voltage is applied under the high pressure condition of the sample chamber (low vacuum) and observation using the retarding method is not possible.

Therefore, the sample chamber 1 in the invention has the double structure and employs the construction in which the inner sample chamber 10a is the one that can be set to a sample chamber pressure of about 1 to about 300 Pa, for example, and the outer sample chamber 10b encompassing the inner sample chamber 10a can be kept always at a high vacuum of about 10⁻⁴ Pa. A sample stage driving body 52 extending from a sample stage control portion 42 and driving the sample stage 36 has an insulator joint 43 at its intermediate portion and insulates the inner sample chamber 10a from the outer sample chamber 10b through insulators 44 and 45. An insulator 46 having a high withstand voltage (dozens of kV, for example) is arranged at an upper part of the inner sample chamber 10a and is brought into close contact with the objective lens 9. The inner sample chamber 10a having low vacuum communicates with the outer sample chamber 10b having high vacuum through the orifice 12 having a diameter of hundreds of microns (μm). The inner sample chamber 10a and the exhaust pipe 18 are electrically insulated by an insulator pipe 50.

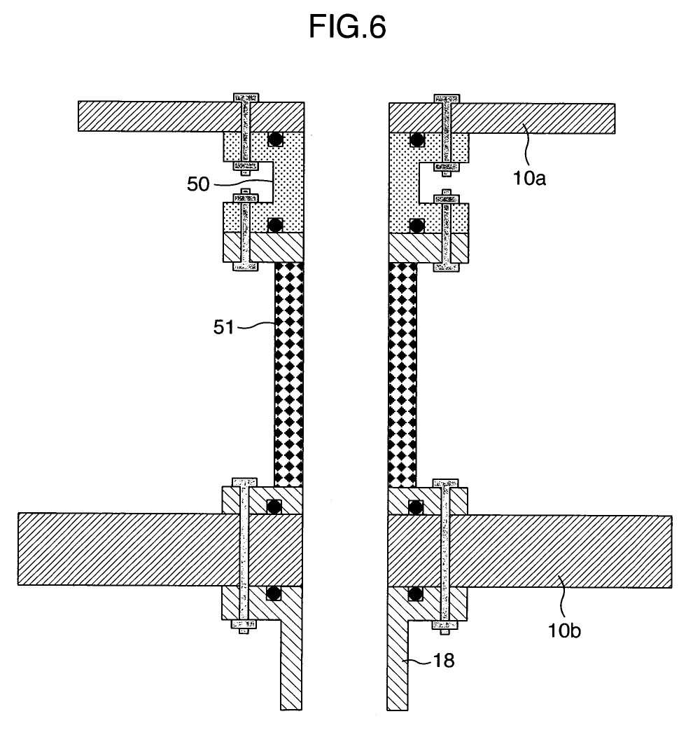

FIG. 6 is a detailed view of electric insulation of the inner sample chamber 10a and the exhaust pipe 18. The inner sample chamber 10a is connected to the exhaust pipe 18 through an insulator pipe 50 and a flexible vacuum pipe 51, and the exhaust pipe 18 exhausts to a low vacuum atmosphere while electric insulation to the outer sample chamber 10b is secured.

Because such a construction is employed, discharge does not occur even when a retarding voltage of −0.5 to −9 kV, for example, is applied from the power source 41 to the inner sample chamber 10a and the sample table 35 and observation can be made even at a high sample chamber pressure (low vacuum). As a result, observation of an acceleration voltage of 1 kV can be made at an acceleration voltage of 10 kV and a retarding voltage of −9 kV but lens aberration can be drastically reduced in comparison with the passage through the objective lens at 1 kV and high resolution can be expected.

Scattering that occurs when the electron beam 7, the reflected electrons from the sample 11 and the secondary electrons impinge against the residual gas molecules can be reduced when the thickness of the insulator 46 arranged at the upper part of the inner sample chamber 10a is rendered thin (1 mm, for example) and the working distance is decreased. Consequently, improvement of S/N and resolution can be expected.

FIG. 5 is a sectional view showing the mode when the sample stage of the scanning electron microscope according to the invention is fitted. Means for operating two flanges 47 and 48 in the interlocking arrangement and inserting the sample into the sample chambers having different pressures is disposed and in this way, the sample can be easily exchanged in the same way as in the prior art. The sample stage driving body 52 extending from the sample stage control portion 42 fixed to the flange 48 on the side of the outer sample chamber has at its distal end the sample stage 36 and the flange 47 for the inner sample chamber is fitted between the flange 48 for the outer sample chamber 48 and the sample stage 36. The sample stage 36 holding the sample 11 on the sample table 35, the flange 47 for the inner sample chamber and the flange 48 for the outer sample chamber can be fitted to and removed from, as a unitary assembly, the sample chamber 1 with the sample stage control portion 42. O rings for vacuum seal are arranged on the contact surfaces of both flanges 47 and 48 with the sample chamber. When the inside of both sample chambers 10a and 10b is exhausted to vacuum while the flanges 47 and 48 are pushed to a sample insertion opening of the inner sample chamber 10a and a sample insertion opening of the outer sample chamber 10b, respectively, the outer sample chamber 10b and the inner sample chamber 10a can be sealed by the flanges 47 and 48, respectively.

According to the invention, the sample chamber has the double structure wherein the inner sample chamber is the one that can be set to a high pressure (low vacuum) and the outer sample chamber encompassing the inner sample chamber is set to a high vacuum. Consequently, observation of the deceleration electric field becomes possible even when the sample chamber pressure is high, the image can be formed at a low acceleration voltage of 5 kV or below and a fine structure of the sample surface can be observed with high resolution and without vacuum evaporation.

It should be further understood by those skilled in the art that although the foregoing description has been made on embodiments of the invention, the invention is not limited thereto and various changes and modifications may be made without departing from the spirit of the invention and the scope of the appended claims.

1. A scanning electron microscope including:
an electron beam source;
a sample chamber; and
an electronic optical system for thinly contracting the electron beam emitted from said electron beam source and scanning on a sample accommodated in said sample chamber;
wherein said sample chamber has an outer sample chamber and an inner sample chamber arranged inside said outer sample chamber and electrically insulated from said outer sample chamber;
each of said outer and inner sample chambers has an independent exhaust system; and
said inner sample chamber communicates with said outer sample chamber through an orifice permitting passage of the electron beam.

2. A scanning electron microscope according to claim 1, wherein said inner sample chamber is kept at low vacuum and said outer sample chamber is kept at high vacuum.

3. A scanning electron microscope according to claim 1, wherein said inner sample chamber is fixed to an objective lens of said electronic optical system through an insulator.

4. A scanning electron microscope according to claim 1, wherein each of said outer and inner sample chambers has an opening portion for inserting a sample, and said scanning electron microscope further includes means for driving a flange for sealing said sample insertion opening portion of said outer sample chamber and a flange for sealing said sample insertion opening portion of said inner sample chamber in the interlocking with each other.

5. A scanning electron microscope according to claim 1, which further includes means positioned in said inner sample chamber, for applying a negative potential to a sample table holding said sample and decelerating the electron beam.

6. A scanning electron microscope according to claim 1, which further includes means positioned in said inner sample chamber, for applying a positive bias voltage to the sample accommodated in said inner sample chamber.

7. A scanning electron microscope according to claim 1, which further includes current detection means for detecting an ion current absorbed in the sample, and wherein said current detection means includes a current-voltage converter for converting the ion current to a voltage, a voltage-frequency converter for converting an output voltage of said current-voltage converter to a frequency, and a photo coupler for converting an output of said voltage-current converter and transmitting and receiving the optical signal.
